(19) United States
(12) Patent Application Publication
(10) Pub. No.: US 2007/0114741 A1
(43) Pub. Date: May 24, 2007

(54) Steamer for beauty purpose

(76) Inventor: Chang Fa Pai, Tao Yuan Hsien (TW)

Correspondence Address: BACON & THOMAS, PLLC, 625 SLATERS LANE, FOURTH FLOOR, ALEXANDRIA, VA, 22314, US

(21) Appl. No.: 11/656,406

(22) Filed: Jan. 23, 2007

Related U.S. Application Data
(63) Continuation-in-part of application No. 11/170,148, filed on Jun. 30, 2005.

(30) Foreign Application Priority Data
May 15, 2006 (TW) 095208256

(51) Int. Cl. B62B 1/00

(52) U.S. Cl. 280/47.131

(57) ABSTRACT

A steamer for beauty treatment is disclosed to include a housing holding an electric heater on the inside, a mounting assembly pivoted to the housing for locking a water container to the inside of the housing for enabling the electric heater to heat water in the water container, and a rotary steam output unit pivoted to the top side of the housing and having a swivel steam nozzle for output of steam from the water container.

### CROSS REFERENCE TO RELATED ART

The present invention is a continuation-in-part of U.S. patent application Ser. No. 11/170,148, filed on Jun. 30, 2005, entitled “Beauty Cart”, now pending.

### BACKGROUND OF THE INVENTION

1. Field of the Invention

The present invention relates to steamers and more particularly, to a steamer for beauty purpose that can be used in a beauty cart.

2. Description of the Related Art

A steamer for use in a beauty-parlour generally comprises a housing, and an electric heater mounted inside the housing for heating water into steam for application. A steamer of this design is an independent product. After other beauty works, the beautician must push the beauty cart away and then carry the steamer to the workplace for treating the client. It is inconvenient to frequently carry the steamer from place to place and to use the steamer in this manner.

### SUMMARY OF THE INVENTION

The present invention has been accomplished under the circumstances in view. According to one aspect of the present invention, a steamer for beauty purpose comprises housing holding an electric heater on the inside, a mounting assembly pivoted to the housing for locking a water container to the inside of the housing for enabling the electric heater to heat water in the water container, and a rotary steam output unit pivoted to the top side of the housing and having a swivel steam nozzle for output of steam from the water container.

According to another aspect of the present invention, the mounting assembly comprises a pivot member pivotally provided at one side of the housing, a U-bar, a connecting rod connected between the pivot member and the U-bar to hold the U-bar in horizontal, a screw rod vertically mounted in the top side of the U-bar, a clamp provided at the top end of the screw rod, and a knob fastened to the bottom end of the screw rod above the bottom side of the U-bar for rotation by the user to adjust the elevation of the clamp.

Further, the housing has a bottom stem, which has the bottom end provided with a wheel or stand for supporting the steamer on the floor.

### BRIEF DESCRIPTION OF THE DRAWINGS

FIG. 1 is an exploded view of a steamer according to the present invention.

FIG. 2 is a perspective view of FIG. 1.

FIG. 3 is a schematic drawing of a part of the present invention, showing the mounting assembly secured the water container in position.

FIG. 4 is an elevational view showing the steamer fastened to a beauty cart.

FIG. 5 is an elevational view of an alternate form of the steamer according to the present invention.

### DETAILED DESCRIPTION OF THE PREFERRED EMBODIMENT

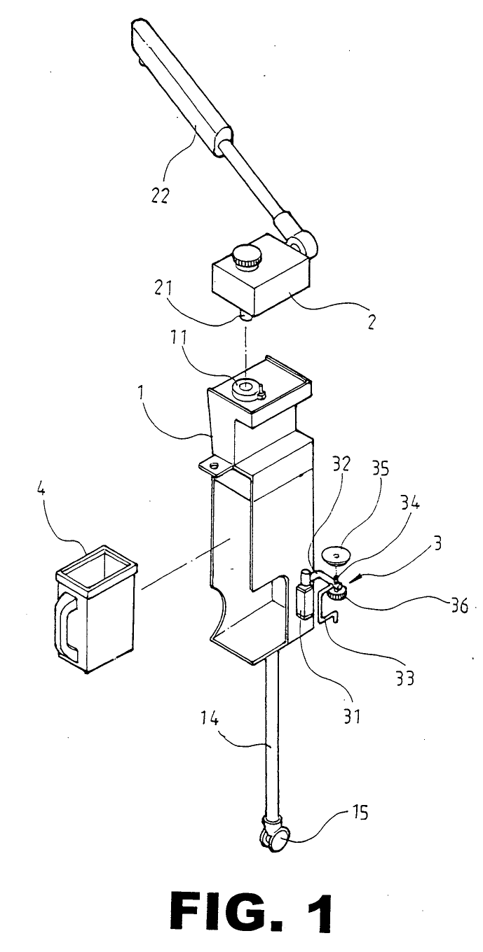

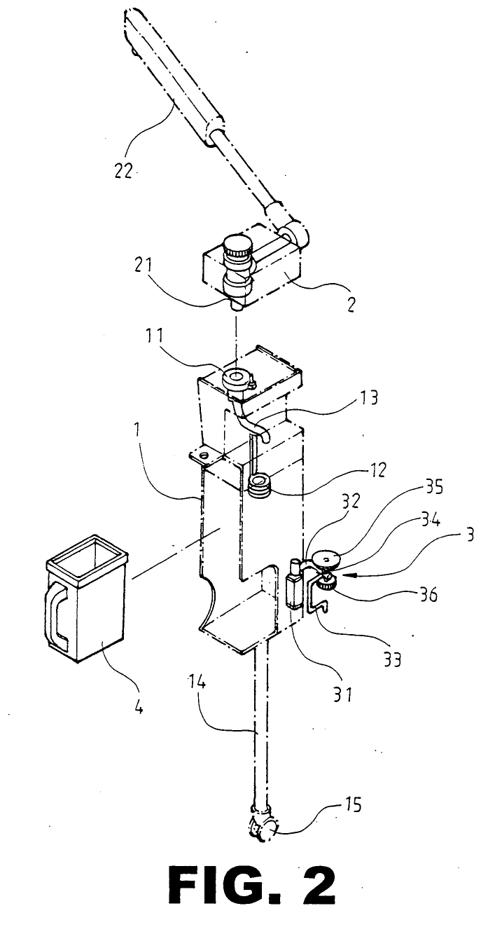

Referring to FIGS. 1 and 2, a steamer in accordance with the present invention is shown comprised of a housing 1, a rotary steam output unit 2, and a mounting assembly 3.

The housing 1 has a pivot holder 11 at the top, an electric heater 12 provided on the inside, and a steam tube 13 provided on the inside and upwardly connected to the pivot holder 11.

The mounting assembly 3 comprises a pivot shaft 31 pivotally provided at one side of the housing 1, a U-bar 33, a connecting rod 32 connected between the pivot shaft 31 and the U-bar 33 to hold the U-bar 33 in horizontal, a screw rod 34 vertically mounted in the top side of the horizontally disposed U-bar 33, a clamp 35 provided at the top end of the screw rod 34, and a knob 36 fastened to the bottom end of the screw rod 34 above the bottom side of the horizontally disposed U-bar 33.

Further, a stem 14 is vertically fixedly provided at the bottom side of the housing 1, having a wheel 15 pivotally mounted on the bottom end.

The rotary steam output unit 2 has a tubular bottom pivot shaft 21 pivoted to the pivot holder 11 of the housing 1 and connected to the steam tube 13, and a swivel steam nozzle 22 coupled to the tubular bottom pivot shaft 21.

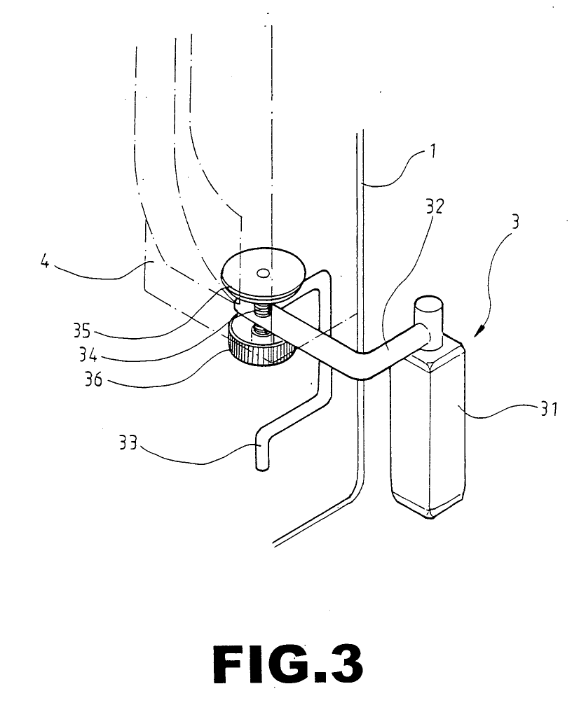

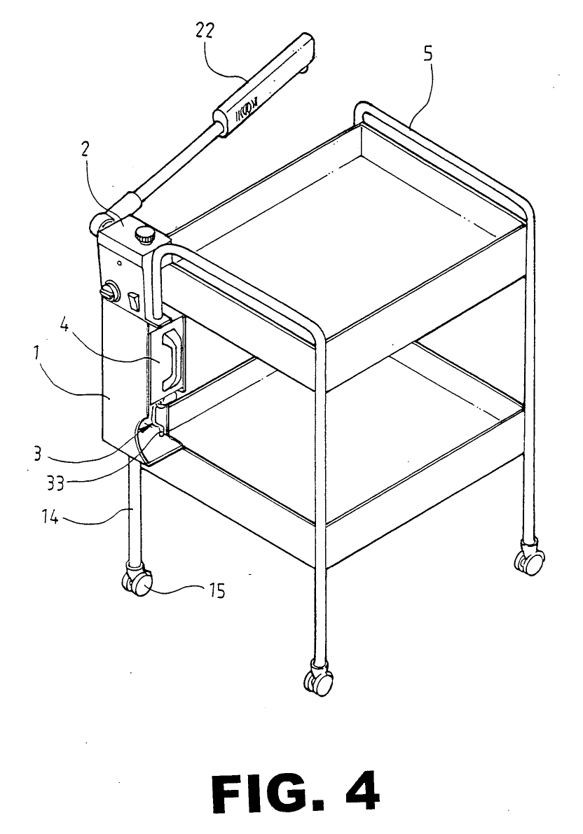

Referring to FIGS. 3 and 4, the steamer is fastened to one side of a beauty cart 5. When in use, the pivot shaft 31 is rotated through an angle relative to the housing 1 to move the horizontally disposed U-bar 33 into the inside of the housing 1, and then a water container 4 is inserted into the inside of the housing 1 and supported on the clamp 35 of the mounting assembly 3, and then the knob 36 is rotated to move the screw rod 34 and the clamp 35 upwards and to further lock the water container 4 to the inside of the housing 1, keeping the electric heater 12 and the bottom end of the steam tube 13 dipped in water contained in the water container 4. The electric heater 12 can then be started to heat water in the water container 4 into steam, enabling the steam to go through the steam tube 13 and the tubular bottom pivot shaft 21 of the rotary steam output unit 2 to the outside of the rotary steam output unit 2 via the swivel steam nozzle 22 for application.

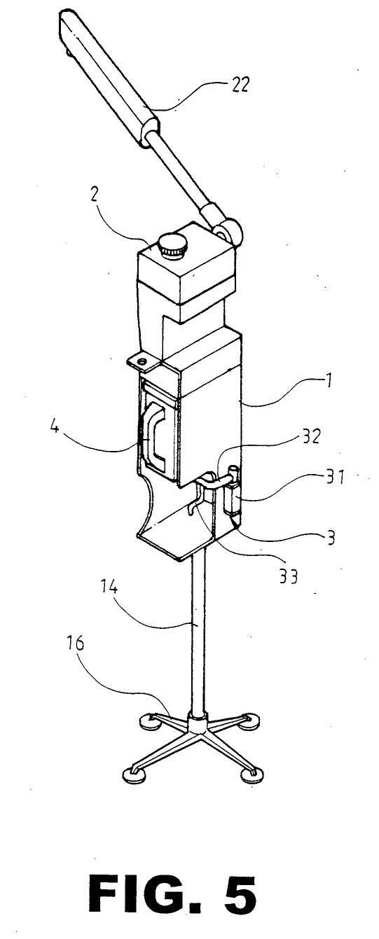

FIG. 5 shows an alternate form of the present invention. According to this embodiment, the stem 14 is supported on a stand 16 that supports the steamer stably on the floor.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A steamer comprising:
a housing, said housing having a pivot holder at a top side thereof, an electric heater provided on the inside thereof, and a steam tube suspending on the inside adjacent to said electric heater and connected to said pivot holder;
a rotary steam output unit, said rotary steam output unit having a tubular bottom pivot shaft pivotally coupled to said pivot holder of said housing and connected to said steam tube, and a swivel steam nozzle coupled to said tubular bottom pivot shaft; and
a mounting assembly for securing a water container in said housing for enabling said electric heater to heat water contained the water container that is inserted into said housing into steam and said steam tube to guide produced steam to said tubular bottom pivot shaft and said swivel steam nozzle, said mounting assembly comprising a pivot member pivotally provided at one side of said housing, a U-bar, a connecting rod connected between said pivot member and said U-bar to hold said U-bar in horizontal, a screw rod vertically mounted in a top side of said U-bar, a clamp provided at a top end of said screw rod, and a knob fastened to a bottom end of said screw rod above a bottom side of said U-bar for rotation by the user to adjust the elevation of said clamp.

2. The steamer as claimed in claim 1, wherein said housing has a bottom stem and a wheel pivotally provided at a bottom end of said bottom stem.

3. The steamer as claimed in claim 1, wherein said housing has a bottom stem and a stand fixedly fastened to a bottom end of said bottoms tem for supporting the steamer on a flat surface.
